(19) United States
(12) Patent Application Publication
(10) Pub. No.: US 2009/0245597 A1
(43) Pub. Date: Oct. 1, 2009

(54) RIDGE REGION EXTRACTION

(76) Inventor: HIROAKI TOYAMA, Tokyo (JP)

Correspondence Address: NEC CORPORATION OF AMERICA, 6535 N. STATE HWY 161, IRVING, TX, 75039, US

(21) Appl. No.: 12/410,698

(22) Filed: Mar. 25, 2009

(30) Foreign Application Priority Data
Mar. 27, 2008 (JP) 2008-083736

(51) Int. Cl. G06K 9/00

(52) U.S. Cl. 382/125

(57) ABSTRACT

This invention includes a ridge region extractor which identifies a ridge region in a digital image based on a correlation value indicating the degree of similarity between each of a plurality of regions of the digital image and each of a plurality of ridge template images associated with a ridge pattern.

This application is based upon and claims the benefit of priority from Japanese Patent Application No. 2008-083736 filed on Mar. 27, 2008, the content of which is incorporated by reference.

### BACKGROUND OF THE INVENTION

1. Field of the Invention

The present invention relates to a ridge region extraction device which extracts a ridge region from an input image, a ridge region extraction system, a ridge region extraction method, and a recording medium.

2. Description of the Related Art

Each person has unique fingerprints which never change trough out a person's lifetime. There are available fingerprint matching devices which match a person by taking advantage of this fact. A fingerprint matching device generally judges whether fingerprints in two fingerprint images to be compared with each other are identical by extracting fingerprint minutiae typified by a point where a ridge ends (an endpoint) and a point where a ridge bifurcates (a bifurcation) from the two fingerprint images and comparing the minutiae.

Alternating ridges and valleys (grooves between ridges) are present in a ridge region (a region with ridges) in a fingerprint image and are characteristically indicated by black lines and white lines with different density values (values indicating brightness). A fingerprint matching device performs the above-described minutiae extraction by taking advantage of this characteristic.

However, ridges and valleys are not always sharp in a ridge region. For example, an incipient ridge may be present in a group of valley pixels, and a sweat pore may be present in a group of ridge pixels.

An incipient ridge is smaller in width than a ridge and appears as a black line in a fingerprint image. If an incipient ridge is present in a group of valley pixels, a fingerprint matching device may erroneously recognize the incipient ridge as a ridge. A sweat pore is smaller in density value than a valley and appears as a white line. If a sweat pore is present in a group of ridge pixels, a fingerprint matching device may erroneously recognize one ridge as two ridges.

Under the circumstances, devices for solving the above-described problem have been proposed, and an example of such a device is disclosed in JP-2007-48000A. A device disclosed in the patent document includes an incipient ridge extracting and eliminating unit and a sweat pore extracting and eliminating unit which extract and eliminate an incipient ridge and a sweat pore, respectively, as described above from a ridge region in an externally inputted fingerprint image.

The incipient ridge extracting and eliminating unit first extracts, from a ridge region, a group of pixels whose density values are set to values regarded as black as a group of ridge candidate pixels. In according to this operation, ridges and incipient ridges are extracted from the ridge region. The incipient ridge extracting and eliminating unit acquires line widths from the group of ridge candidate pixels in order to distinguish between the ridges and the incipient ridges. Since an incipient ridge has the characteristic in which its line width smaller than the line width of a ridge and is present in a group of valley pixels, the incipient ridge extracting and eliminating unit identifies, as an incipient ridge, a part of the group of ridge candidate pixels whose line width is smaller than a predetermined threshold and changes the density values of a group of pixels corresponding to the incipient ridge to a density value corresponding to a valley.

The sweat pore extracting and eliminating unit first extracts, from the ridge region, a group of pixels whose density values are set to values regarded as white, as a group of valley candidate pixels. In according to this operation, valleys and sweat pores are extracted from the ridge region. The sweat pore extracting and eliminating unit acquires density values from the group of valley candidate pixels in order to distinguish between the valleys and the sweat pores. Since a sweat pore has the characteristic in which its density value is smaller than the density value of a valley and is present in a group of ridge pixels, the sweat pore extracting and eliminating unit identifies, as a sweat pore, a region whose density values are smaller than a predetermined threshold and changes the density values of pixels corresponding to the sweat pore to a density value corresponding to a ridge.

According to the device disclosed in the above-described patent document, since incipient ridges and sweat pores are removed from a ridge region, the ridge region is sharp in a fingerprint image. For this reason, use of a fingerprint image which has been subjected to image processing by the device allows an improvement in matching accuracy.

If fingerprint matching is performed using a fingerprint image, the fingerprint image does not always include only a ridge region. For example, a non-ridge region in which a character or the like appears as a black line is often present in a latent print image of a fingerprint deposited on a substance left behind or the like, in addition to a ridge region.

In the related art, at the time of fingerprint matching using a latent print image, the process of extracting minutia from the latent print image is performed without identifying a ridge region, or an operator performs the work of identifying a ridge region in the latent print image in advance.

If the process of extracting minutia is performed without identifying a ridge region, a fingerprint matching device may perform an erroneous process of extracting minutia from a non-ridge region, and fingerprint matching accuracy may deteriorate. On the other hand, if an operator performs the work of identifying a ridge region, although a certain degree of matching accuracy is ensured, operating costs will be incurred. For this reason, there is a need for a device that is capable of automatically extracting a ridge region from a latent print image.

The device disclosed in the above-described patent document has the function of sharpening a ridge region in a fingerprint image. However, the function is based on the premise that only a ridge region is present in a fingerprint image. For this reason, if a non-ridge region is present in a fingerprint image, the non-ridge region may be erroneously recognized as a ridge region and may be sharpened.

### SUMMARY OF THE INVENTION

An object of the present invention is to provide a ridge region extraction device capable of automatically extracting a ridge region from an input image, a ridge region extraction system, a ridge region extraction method, and a recording medium on which a program for causing a computer to perform the method is recorded.

A ridge region extraction device according to the present invention intended to achieve the above-described object comprises a ridge region extractor which identifies a ridge region in a digital image based on a correlation value indicating the degree of similarity between each of a plurality of regions of the digital image and each of a plurality of ridge template images associated with a ridge pattern.

A ridge region extraction system according to the present invention intended to achieve the above-described object comprises a storage device which stores a plurality of ridge template images associated with a ridge pattern and a ridge region extraction device which extracts, for a digital image, a ridge region in the digital image using the plurality of ridge template images, and the ridge region extraction device comprises a ridge region extractor which identifies the ridge region in the digital image based on a correlation value indicating the degree of similarity between each of a plurality of regions of the digital image and each of the plurality of ridge template images.

A ridge region extraction method according to the present invention intended to achieve the above-described object is a method for extracting a ridge region in a digital image, and the ridge region in the digital image is identified based on a correlation value indicating the degree of similarity between each of a plurality of regions of the digital image and each of the plurality of ridge template images.

A recording medium on which a program is recorded according to the present invention intended to achieve the above-described object is a recording medium on which a program, for causing a computer to perform a process of extracting a ridge region in a digital image, and for causing the computer to perform a procedure for identifying the ridge region in the digital image based on a correlation value indicating the degree of similarity between each of a plurality of regions of the digital image and each of the plurality of ridge template images, is recorded.

According to the present invention, the device identifies a ridge region based on a correlation value indicating the degree of similarity with a ridge template image. Accordingly, even if both a ridge region and a non-ridge region are present in an input image, the device itself can distinguish the ridge region from the non-ridge region by calculating a correlation value for each region. It is thus possible to automatically extract a ridge region in an input image.

The above and other objects, features, and advantages of the present invention will become apparent from the following description with reference to the accompanying drawings which illustrate an example of the present invention.

### BRIEF DESCRIPTION OF THE DRAWINGS

FIG. 1 is a block diagram showing the configuration of an exemplary embodiment of a ridge region extraction system according to the present invention;

FIG. 2 is a block diagram showing the configuration of a ridge region extractor according to this exemplary embodiment;

FIG. 3(A) is a schematic view showing an example of a ridge template image according to this exemplary embodiment;

FIG. 3(B) is a schematic view showing an example of the ridge template image according to this exemplary embodiment;

FIG. 3(C) is a schematic view showing an example of the ridge template image according to this exemplary embodiment;

FIG. 3(D) is a schematic view showing an example of the ridge template image according to this exemplary embodiment;

FIG. 3(E) is a schematic view showing an example of the ridge template image according to this exemplary embodiment;

FIG. 3(F) is a schematic view showing an example of the ridge template image according to this exemplary embodiment;

FIG. 3(G) is a schematic view showing an example of the ridge template image according to this exemplary embodiment;

FIG. 3(H) is a schematic view showing an example of the ridge template image according to this exemplary embodiment;

FIG. 4 is a flow chart showing the procedure for the operation of extracting a ridge region according to this exemplary embodiment;

FIG. 5 is a view showing an input image according to this exemplary embodiment;

FIG. 6(A) is a view showing pixels of the input image according to this exemplary embodiment associated with a coordinate system;

FIG. 6(B) is a view showing values obtained by subtracting the average value of density values from each density value for a local image according to this exemplary embodiment and values obtained by subtracting the average value of density values from each density value for a ridge template image according to this exemplary embodiment;

FIG. 7 is a view showing a ridge pattern image according to this exemplary embodiment;

FIG. 8(A) is a view for explaining the operation of calculating a ridge confidence factor according to this exemplary embodiment;

FIG. 8(B) is a view for explaining the operation of calculating a ridge confidence factor according to this exemplary embodiment;

FIG. 9 is a view showing a ridge region image according to this exemplary embodiment; and

FIG. 10 is a view showing a composite image according to this exemplary embodiment.

### EXEMPLARY EMBODIMENT

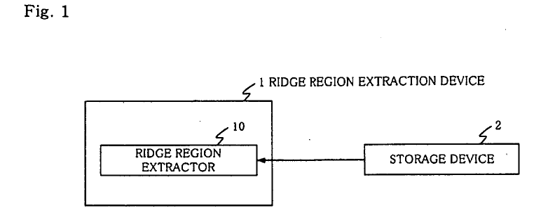

FIG. 1 shows an exemplary embodiment of a ridge region extraction system including ridge region extraction device 1 which extracts a ridge region from an input image and storage device 2 which stores a plurality of ridge template images, each including pixels with density values set in association with a ridge pattern.

The configuration of ridge region extraction device 1 will be described first.

Ridge region extraction device 1 is a computer which performs predetermined processing in accordance with a program and includes ridge region extractor 10.

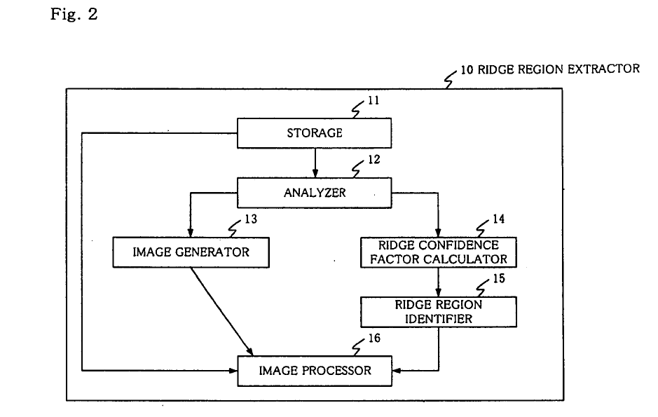

The configuration of ridge region extractor 10 will be described with reference to FIG. 2.

Ridge region extractor 10 shown in FIG. 1 includes storage 11, analyzer 12, image generator 13, ridge confidence factor calculator 14, ridge region identifier 15, and image processor 16, as shown in FIG. 2.

Storage 11 stores an input image, the above-described program, and the like. An input image is, for example, a digital image of a latent print or the like and is supplied from an image input device (e.g., a scanner).

Analyzer 12 calculates, for an input image stored in storage 11, correlation values (values indicating the degree of similarity in density distribution) with respect to each of a plurality of ridge template images stored in storage device 2. Analyzer 12 selects one of the ridge template images such that the correlation value with respect to the ridge template image has the highest absolute value.

Image generator 13 generates a ridge pattern image in which the density values of pixels are each calculated on the basis of a correlation value corresponding to a ridge template image selected by analyzer 12.

Ridge confidence factor calculator 14 calculates, for each pixel for which a correlation value has been calculated by analyzer 12, a ridge confidence factor which is a value indicating the probability that the pixel is a part of a ridge region on the basis of a correlation value corresponding to a ridge template image selected by analyzer 12.

Ridge region identifier 15 identifies a ridge region on the basis of a correlation value, a ridge direction, and a ridge width corresponding to a ridge template image selected by analyzer 12 and a ridge confidence factor calculated by ridge confidence factor calculator 14 for each pixel.

Image processor 16 performs the process of combining an input image stored in storage 11 with a ridge pattern image generated by image generator 13 using ridge confidence factors calculated by ridge confidence factor calculator 14. Image processor 16 performs, on a composite image, the process of changing the density value of a pixel which does not belong to a ridge region identified by ridge region identifier 15 to a value corresponding to white. Note that image processor 16 sends out a processed image to an image output device (e.g., a fingerprint matching device).

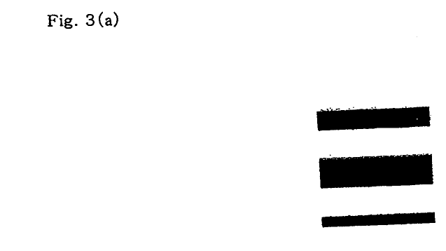

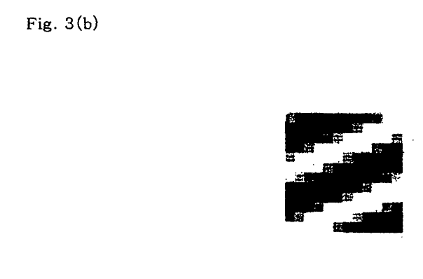

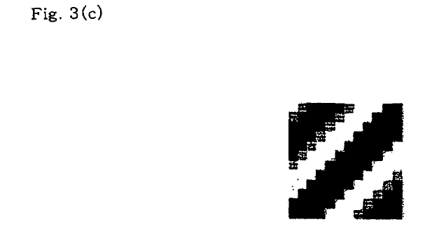

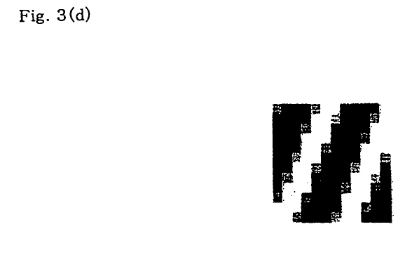

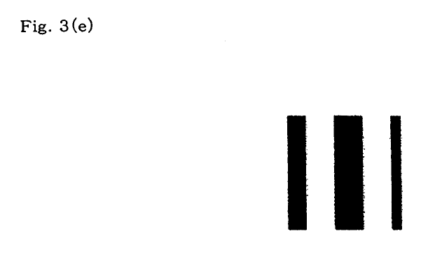

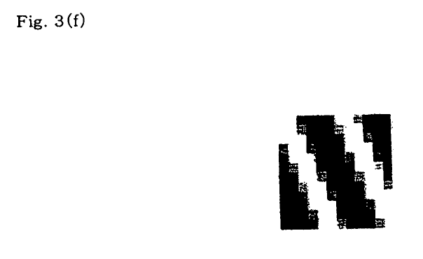

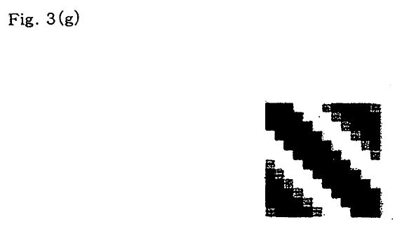

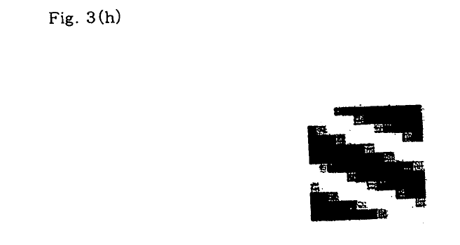

A ridge template image to be stored in storage device 2 will be described with reference to FIGS. 3(A) to 3(H).

In FIGS. 3(A) to 3(H), a black and gray portion indicates a ridge while a white portion indicates a valley. The center pixel of a ridge template image is predetermined to be black.

In this exemplary embodiment, images of a ridge pattern with a predetermined line width (thickness) corresponding to eight directions obtained when the ridge pattern is rotated from a horizontal direction to run in each of the directions (a rotation angle is incremented by π/8) are stored as ridge template images in storage device 2, as shown in FIGS. 3(A) to 3(H).

Note that the number of types of ridge widths is not limited to one and is set to three in this exemplary embodiment. That is, in this exemplary embodiment, storage device 2 stores a total of 24 (3×8) ridge template images associated with combinations of one of the ridge widths and one of the ridge directions.

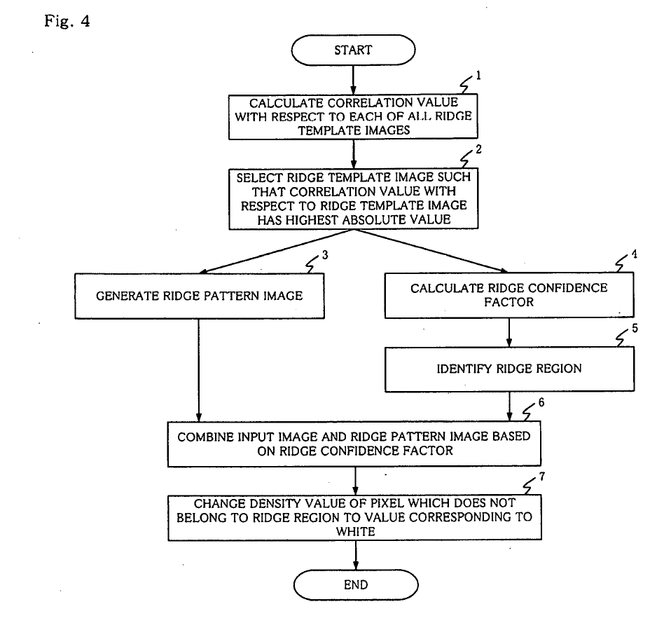

The operation of extracting a ridge region according to this exemplary embodiment will be described with reference to FIG. 4.

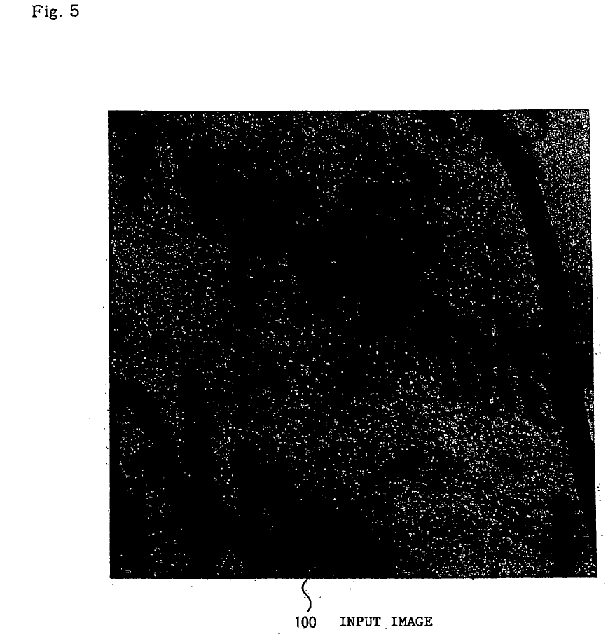

Assume in this exemplary embodiment that input image 100 shown in FIG. 5 is stored in storage 11.

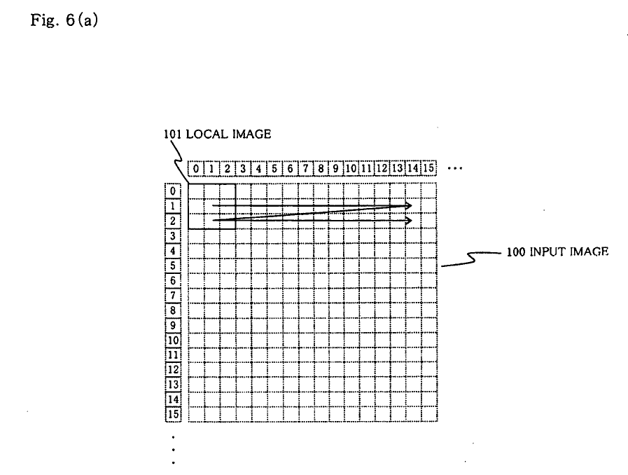

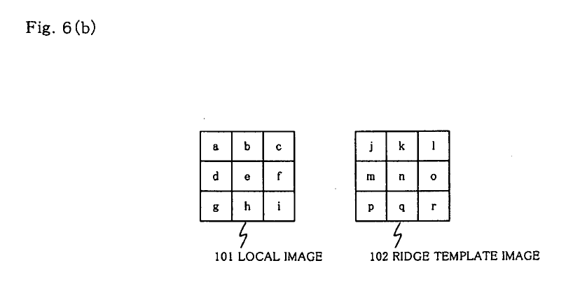

In step 1, analyzer 12 calculates, for input image 100, correlation values with respect to each of the ridge template images stored in storage device 2. The operation in step 1 will be described in detail with reference to FIGS. 6(A) and 6(B).

First, analyzer 12 reads out density values of local image 101 which is an image (an image composed of pixels located at coordinates (0,0) to (2,2)) of the same size as the ridge template images stored in storage device 2. Note that although the size of the ridge template images is not particularly limited, the size is preset to a size of 3×3 in this exemplary embodiment.

Analyzer 12 calculates the average value of the density values of local image. 101 and the average value of the density values of ridge template image 102 which is one of the ridge template images and calculates, for each pixel, a value obtained by subtracting the corresponding average value from the density value.

Analyzer 12 calculates correlation value S1 using equation (1) below. At this time, analyzer 12 sets the calculated correlation value as a correlation value for the center pixel.

S1=(a*j+b*k+ . . . +i*r)/(V*W) (1)

In equation (1) above, V is the square root of the sum of the squares of a to i shown in FIG. 6(B), and W is the square root of the sum of the squares of j to r shown in FIG. 6(B).

A correlation value calculated by equation (1) above is a value in the range of −1 to 1. The probability that local image 101 is an image of a ridge becomes higher as the correlation value approaches 1. On the other hand, the probability that local image 101 is an image of a valley becomes higher as the correlation value approaches −1.

Analyzer 12 calculates a correlation value for each of the ridge template images stored in storage device 2, using the above-described equation. Analyzer 12 then reads out the density values of a local image (an image composed of pixels located at coordinates (1,0) to (3,2)) obtained by horizontally shifting local image 101 by one pixel. Analyzer 12 calculates a correlation value for each of the ridge template images in the same manner as in the case of local image 101.

When correlation values for the center pixels of all local images are calculated in the above-described manner, analyzer 12 selects, for each center pixel, one of the ridge template images in step 2 such that the correlation value with respect to the ridge template image has the highest absolute value. Note that analyzer 12 sets a correlation value for a pixel (e.g., a pixel located at coordinates (0,0)) for which a correlation value has not been calculated to 0 in the operation in step 1.

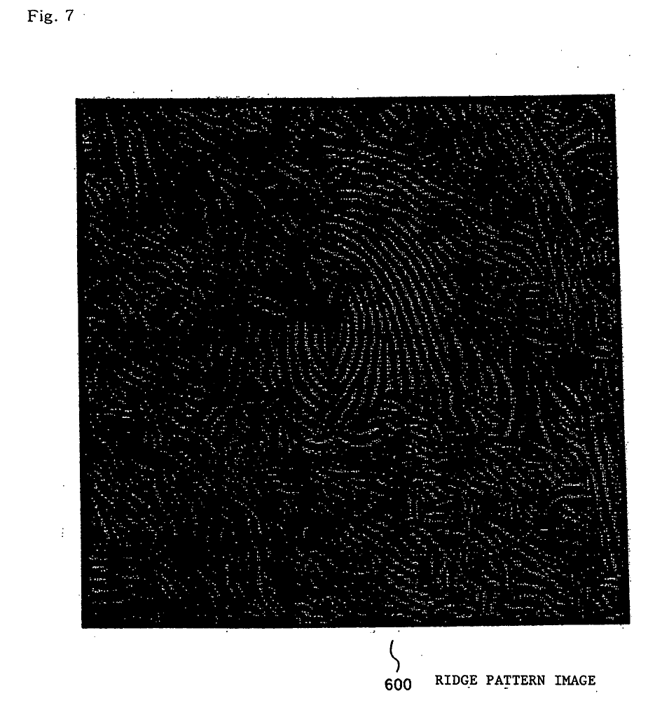

When the correlation values for the pixels of the input image are inputted from analyzer 12, image generator 13 generates a ridge pattern image in which the density values of pixels have been calculated, using equation (2) below in step 3. Ridge pattern image 600 generated at this time is shown in FIG. 7.

density value=intermediate density value+(correlation value*intermediate density value) (2)

intermediate density value=(upper density limit+lower density limit)/2 (3)

In equation (2), “intermediate density value” represents the intermediate value between the upper limit of a density range (“upper density limit”) and the lower limit (“lower density limit”) set in image generator 13, as indicated by equation (3) above. For example, if the density range is set between 0 and 255, an upper density limit, a lower density limit, and an intermediate density value are 255, 0, and 127, respectively.

Since the density values of ridge pattern image 600 are set by equation (2) above, ridge pattern image 600 is an image in which the contrast between ridges and valleys is emphasized.

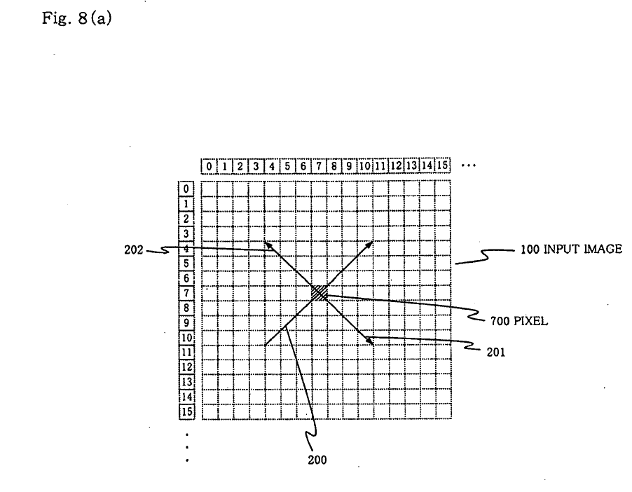

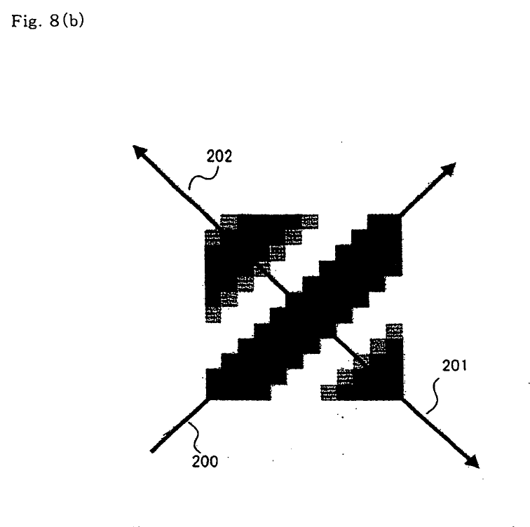

In parallel with the operation in step 3, ridge confidence factor calculator 14 calculates a ridge confidence factor for each of the pixels of the input image for which the correlation values have been calculated, using equation (4) below in step 4. The operation in step 4 will be described in detail with reference to FIGS. 8(A) and 8(B).

FIG. 8(A) shows a ridge direction corresponding to one of the ridge template images selected by analyzer 12 and directions orthogonal to the ridge direction for pixel 700 which is one of the pixels that serves as a calculation object in input image 100. In FIG. 8(A), arrow 200 indicates the ridge direction while arrow 201 and arrow 202 indicate the directions orthogonal to the ridge direction.

ridge confidence factor=SQRT{(cumulative sum of positive correlation values)*(absolute value of cumulative sum of negative correlation values)} (4)

In equation (4) above, “SQRT” represents a square root, and “cumulative sum of positive correlation values” and “cumulative sum of negative correlation values” represent values obtained by separately adding positive ones and negative ones of the correlation values for a predetermined number of pixels located in the direction indicated by arrow 201 or arrow 202 with respect to pixel 700, in ascending order of the distance from pixel 700.

Note that if there is no positive correlation value at the time of calculating a ridge confidence factor or if there is no negative correlation value, ridge confidence factor calculator 14 sets the ridge confidence factor to 0.

In this exemplary embodiment, a ridge appears as a black line in a ridge template image. Accordingly, in an input image, a ridge portion has a positive correlation value while a valley portion has a negative correlation value. A ridge region is characterized by having a horizontal stripe pattern of alternating ridges and valleys as seen in a direction orthogonal to a ridge direction. For this reason, assuming that pixel 700 is the center pixel of a ridge image shown in FIG. 8(B), both pixels with positive correlation values and pixels with negative correlation values are present in the directions orthogonal to the ridge direction.

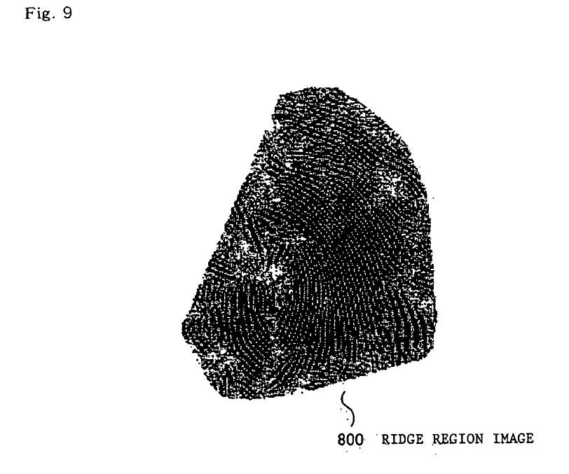

When ridge confidence factor calculator 14 completes the calculation of a ridge confidence factor for each pixel, ridge region identifier 15 identifies a ridge region on the basis of the correlation value, the ridge direction, and the ridge width corresponding to the ridge template image selected by analyzer 12 and the ridge confidence factor for each pixel in step 5. Image 800 of the ridge region identified by ridge confidence factor calculator 14 at this time is shown in FIG. 9. Note that image 800 has been subjected to an image process for whitening a background region (a region other than the ridge region) in FIG. 9.

In this exemplary embodiment, ridge region identifier 15 extracts, from among the pixels for which the ridge confidence factors have been calculated, ones whose ridge confidence factors are not less than predetermined threshold t1. Ridge region identifier 15 couples some pixels surrounding each of the extracted pixels which have a difference of not more than threshold t2 in a ridge direction (a difference between rotation angles corresponding to ridge template images) and which have a difference of not more than threshold t3 in ridge width to the pixel and which form a ridge region.

Note that if ridge region identifier 15 identifies a plurality of possible ridge regions in an input image, it identifies, as a ridge region, one of the regions in which the sum of ridge confidence factors is the largest.

When ridge region identifier 15 identifies a ridge region, image processor 16 performs the process (a blend) of combining input image 100 with ridge pattern image 600 using the ridge confidence factors in step 6. In this exemplary embodiment, image processor 16 calculates the density value of each pixel in a composite image of input image 100 and ridge pattern image 600 on the basis of equation (4) below.

density value=(p/q)*x+{(q−p)/q}*y (5)

In equation (5) above, x and y represent the density values of pixels at the same coordinates of ridge pattern image 600 and input image 100, p represents a ridge confidence factor, and q is a maximum value of the range of values that the ridge confidence factor can take and is a value necessary for determining to what degree ridge pattern image 600 is made transparent when ridge pattern image 600 is combined with input image 100. For example, if p and q are equivalent, the density value for ridge pattern image 600 is adopted as the density value for the composite image without change.

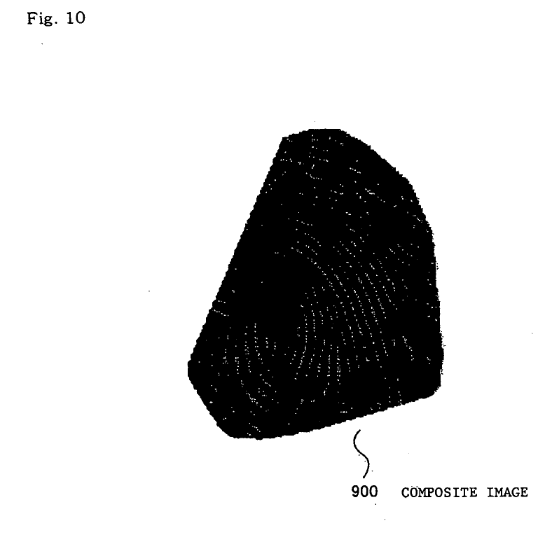

When image processor 16 completes the calculation of the density value of each pixel in the composite image, it performs the process of changing the density value of each pixel that does not belong to the ridge region identified by ridge region identifier 15 of the pixels in the composite image to a value corresponding to white in step 7. Composite image 900 formed by the operations in step 6 and step 7 by image processor 16 is shown in FIG. 10.

Note that, in the operation in step 5, ridge region identifier 15, instead of identifying only one ridge region, may regard a region as a ridge region if, for example, the sum of ridge confidence factors is larger than a predetermined value in the region. This allows ridge region identifier 15 to extract a plurality of regions constituting an original ridge region without omission even if the ridge region is divided into the regions by a background which divides ridges in an input image.

In this exemplary embodiment, ridge region extraction device 1 identifies a ridge region according to ridge confidence factors calculated on the basis of correlation values, each indicating the degree of similarity with a ridge template image. Accordingly, even if both ridge regions and non-ridge regions are present in an input image, the device itself can distinguish the ridge regions from the non-ridge regions by calculating ridge confidence factors for each region. It is thus possible to automatically extract a ridge region in an input image.

In this exemplary embodiment, not only the automatic extraction of a ridge region but also the sharpening of the ridge region is performed. For this reason, use of a fingerprint image which has been subjected to image processing by a system according to this exemplary embodiment allows an improvement in matching accuracy.

Note that the present invention is not limited to storage device 2 configured as a device separate from ridge region extraction device 1, as in the above-described exemplary embodiment, and storage device 2 may be configured to be included in storage 11 of ridge region extraction device 1. Even in this case, the operation of each component does not change, and it is possible to achieve the same advantages as in a case where ridge region extraction device 1 and storage device 2 are provided as separate configurations.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A ridge region extraction device comprising a ridge region extractor which identifies a ridge region in a digital image based on a correlation value indicating the degree of similarity between each of a plurality of regions of the digital image and each of a plurality of ridge template images associated with a ridge pattern.

2. The ridge region extraction device according to claim 1, wherein each of the plurality of ridge template images comprises a ridge pattern with pixel density values different from pixel density values of any other one of the plurality of ridge template images.

3. The ridge region extraction device according to claim 1, wherein the ridge region extractor calculates, for each of the plurality of regions of the digital image, a correlation value indicating the degree of similarity with each of the plurality of ridge template images, calculates a ridge confidence factor indicating a probability that each region is a ridge region using the correlation values, and identifies one of the regions which has the ridge confidence factor larger than a predetermined threshold as the ridge region.

4. The ridge region extraction device according to claim 3, wherein the ridge region extractor comprises
a storage medium which stores the digital image,
an image generator which generates a ridge pattern image based on the correlation values, and
an image processor which combines the digital image with the ridge pattern image using the ridge confidence factors such that areas other than the ridge region have same density values.

5. The ridge region extraction device according to claim 3, wherein
each of the plurality of ridge template images is associated with a ridge width and a ridge direction, and
the ridge region extractor comprises
an analyzer which selects one of the ridge template images such that the correlation value with respect to the ridge template image has the highest absolute value and
a ridge region identifier which calculates a difference in ridge width and a difference in ridge direction between one of the ridge template images selected for the ridge region by the analyzer and one of the ridge template images selected for each of surrounding regions adjacent to the ridge region by the analyzer, and which identifies one of the peripheral regions in which the calculated differences fall within predetermined ranges, respectively, as being included in the ridge region.

6. The ridge region extraction device according to claim 5, wherein the ridge region extractor includes a ridge confidence factor calculator which calculates the ridge confidence factor of each region using the correlation value of one of the regions located in a direction orthogonal to the ridge direction corresponding to the ridge template image selected for the region by the analyzer.

7. A ridge region extraction system comprising:
a storage device which stores a plurality of ridge template images associated with a ridge pattern; and
a ridge region extraction device which extracts, for a digital image, a ridge region in the digital image using the plurality of ridge template images,
wherein the ridge region extraction device comprises a ridge region extractor which identifies the ridge region in the digital image based on a correlation value indicating the degree of similarity between each of a plurality of regions of the digital image and each of the plurality of ridge template images.

8. A method for extracting a ridge region in a digital image, comprising
identifying the ridge region in the digital image based on a correlation value indicating the degree of similarity between each of a plurality of regions of the digital image and each of the plurality of ridge template images.

9. The method according to claim 8, further comprising:
calculating a ridge confidence factor indicating a probability that each region is the ridge region that uses the correlation values; and
identifying, as the ridge region, one of the regions which has the ridge confidence factor larger than a predetermined threshold.

10. The method according to claim 9, further comprising:
generating a ridge pattern image based on the correlation values; and
combining the digital image with the ridge pattern image using the ridge confidence factors such that parts other than the ridge region have the same density values.

11. The method according to claim 9, wherein
each of the plurality of ridge template images is associated with a ridge width and a ridge direction, and
the method further comprises
selecting one of the ridge template images such that the correlation value with respect to the ridge template image has the highest absolute value,
calculating a difference in ridge width and a difference in ridge direction between one of the ridge template images selected for the ridge region and one of the ridge template images selected for each of the surrounding regions adjacent to the ridge region, and
identifying one of the peripheral regions in which the calculated differences fall within predetermined ranges, respectively, as being included in the ridge region.

12. The method according to claim 11, further comprising calculating the ridge confidence factor of each region using the correlation value of one of the regions located in a direction orthogonal to the ridge direction corresponding to the ridge template image selected for the region.

13. A recording medium on which a program for causing a computer to perform a process of extracting a ridge region in a digital image is recorded,
wherein a program causes the computer to perform a procedure for identifying the ridge region in the digital image based on a correlation value indicating the degree of similarity between each of a plurality of regions of the digital image and each of the plurality of ridge template images.

14. The recording medium according to claim 13, wherein
a program causes the computer to perform
a procedure for calculating a ridge confidence factor indicating a probability that each region is the ridge region using the correlation values and
a procedure for identifying, as the ridge region, one of the regions which has the ridge confidence factor larger than a predetermined threshold.
